(19) United States
(12) Patent Application Publication
(10) Pub. No.: US 2013/0135617 A1
(43) Pub. Date: May 30, 2013

(54) PLASMONIC OPTICAL TRANSDUCER

(71) Applicants: Andrew David PRIS, Clifton Park, NY (US); Windsor Paige OSBERG, Chicago, IL (US); Radislav Alexandrovich POTYRAILO, Niskayuna, NY (US)

(72) Inventors: Andrew David PRIS, Clifton Park, NY (US); Windsor Paige OSBERG, Chicago, IL (US); Radislav Alexandrovich POTYRAILO, Niskayuna, NY (US)

(73) Assignee: GENERAL ELECTRIC COMPANY, Schenectady, NY (US)

(21) Appl. No.: 13/308,159

(22) Filed: Nov. 30, 2011

(51) Int. Cl. G01N 21/55; G01J 3/28

(52) U.S. Cl. 356/326; 356/445

(57) ABSTRACT

A transducer includes a source of electromagnetic radiation, a substrate having a plurality of flow through passages and a receiver. The plurality of nanoparticles is disposed on the substrate and includes a material having a dielectric constant being arranged to support a photonically excited Plasmon in response to electromagnetic radiation from the source. The receiver measures the electromagnetic radiation and is disposed in optical communication with the substrate.

### TECHNICAL FIELD

This invention relates, in general, to transducers, and more particularly to transducer systems and methods for use in detecting analyte targets.

### BACKGROUND ART

There are multiple biological detection technologies available with requirements that depend upon the intended setting of use. In most cases, the performance requirements (e.g., limit of detection, sensitivity, confidence) are compromised while the non-performance requirements (e.g., time, ease of use, portability, sample volume) are made more rigorous as the setting shifts from the analytical laboratory to the field. The compromising of performance requirements and enhancement of non-performance requirements can be understood as the technologies transition from the benchtop to the field. For example, one of the most commonly used plasmonic methods is Surface Plasmon Resonance (SPR), which provides excellent limits of detection with high specificity and confidence but suffers in portability (i.e., meets the performance requirements at the cost of the non-performing requirements).

Ideal in the field setting would be a technology that has excellent limits of detection, large dynamic range, reduced reagents, and orthogonal detection means to confirm analyte identity. SPR can achieve many of these requirements as it is a real-time, label-free biological detector with excellent limits of detection and high dynamic range. Moreover, SPR is able to increase the confidence in the detection through real-time determination of binding constants to rule out false positives. However, SPR requires costly and bulky engineering and process steps to suppress multiple noise sources, which has limited its portability and use in the field. It would be advantageous if a mechanism could be identified to suppress environmental noise and retain the positive features of SPR, yet increase portability and ease of use. Briefly, the source of the noise for SPR is inherently linked to its signal generation mechanism. The physical phenomenon behind SPR is the coupling of photon energy and momentum into the electrons in the conduction band of a material that has a negative real, and slightly positive imaginary, dielectric constant (e.g., gold, silver). The conditions to achieve this coupling for SPR are highly dependent on the refractive index at the metallic film surface within 100's of microns in the plane of the metallic film and up to 200-1000 nm into the bulk above the surface. These excited electrons are referred to as surface propagating plasmons (SPP) and all methods that employ SPP are collectively referred to as SPR.

The physical arrangement of components to allow for the excitement of SPP in various SPR apparatus are varied and include in non-limiting examples: Kretschmann configuration, Otto configuration, grating, resonating microspheres. Binding of an analyte to a receptor on a metal film, which usually occurs within <50-nm of the metal surface, alters the refractive index at the metal film and changes the conditions required to excite the surface propagating plasmons (SPP), thereby generating signal. Noise originates from changes to the refractive index in the bulk solution, such as temperature fluctuations as low as 1 mK. The overall signal-to noise ratio (S/N), defined by the fill factor (the fraction of the sensing volume occupied by the biological layer relative to the sensing volume occupied by the bulk) is thus low for SPR. Because of SPP sampling a large quantity of the bulk relative to the analyte layer, all SPR embodiments must improve S/N by using engineering methods that suppress noise or result in the analyte layer to fill a greater fraction of the sensing volume, but such engineering solutions decrease the portability of the unit by greatly expanding the footprint of the instrument. Examples include extensive efforts to thermally stabilize the unit, samples, and reagents as well as employing a ligand modified dextran layer on the gold to result in the analytical volume more closing matching the sensing volume.

In another example, localized surface plasmon resonance (LSPR) requires nanosized features (e.g., features sized preferably near 1-1600 nm). The composition (which must still have a negative real, and positive imaginary dielectric constant) and size and shape (both which are nanosized) along with the local refractive index above the LSPR active feature determine what energy of photon will be absorbed and coupled to a LSPR. Consequently, the size, shape and material of the LSPR feature is chosen such that it absorbs photons that exist within the ultraviolet-visible-near infrared wavelength (preferably 100-1600 nm and more preferably between 600-1000 nm). A critical difference between LSPR and SPR is that the localized plasmons are constrained to being sensitive to refractive index within 30-nm of the LSPR supporting feature. These systems that allow for only localized surface plasmons have a much better fill factor than SPR and thus require less engineering to increase S/N. However the required nanosized dimensions of the LSPR feature have been shown to significantly reduce the mass flux of the analyte (e.g., target) to the nanosized surface, thus increasing the assay time, sample volume, and/or sample concentration to match mass flux achieved to macro sized features, such as SPR (Paul E. Sheehan and Lloyd J. Whitman, Nanoletters 2005, 5 (4), 803-807).

Further, various other plasmonic detection methods are subject to many of the above indicated limitations with such methods utilizing substrate materials that are sensitive to local changes in the refractive index that affects which specific wavelength of light excites the plasmons and may be detected by a receiver.

Thus, there is a need for systems and methods for field detection which maintain accuracy while increasing the speed with which results are obtained and increase portability.

### SUMMARY OF THE INVENTION

The present invention provides, in one aspect, a transducer system which includes a source of electromagnetic radiation, a flow-through substrate with a plasmonic material disposed thereon and a plasmonic receiver. The substrate allows for a flow of analytes therethrough and allows analyte to interact with the plasmonic entity(ies) disposed theron and therethrough the substrate. The substrate also allows for the plasmonic entities to response to electromagnetic radiation from the source of electromagnetic radiation being radiated on the plurality or singular plasmonic active entities (e.g., nanoparticle(s) or nanorod(s)). The plasmonic entities are positioned in the channels to achieve preferential localized Surface Plasmon Resonance (LSPR) response. The number of plasmonic active entities per flow-through channel within the support substrate is at least 5 or more. The plasmonic receiver examines the change in the response of the plasmonic active entities thereon and therethrough the substrate in response to interaction with analyte flowed therethrough the substrate.

The present invention provides, in another aspect, a method to create a flow-through substrate with a plasmonic material disposed thereon and therethrough. In a specific embodiment, the non-aggregated plasmonic properties of the nanofeature is retained after being deposited on and through the substrate through either layer-by-layer deposition or covalent attachment. These embedded plasmonic nanofeatures are preferably nanoparticles or nanorods. The plasmonic entities are positioned in the channels to achieve preferential localized Surface Plasmon Resonance (LSPR) response. The number of plasmonic active entities per flow-through channel within the support substrate is at least 5 or more. The nanofeature can be modified (or left unmodified) to provide for analyte specificity prior to embedding in the substrate, and in a preferred embodiment this method allows for the ability to further modify the plasmonic nanofeature on and through the substrate.

The present invention provides, in another aspect, a method for use in detecting a target which includes disposing a plasmonic material on a flow through substrate. In a specific embodiment, the present invention provides a method for use in detecting a change in a local refractive index which includes embedding a plurality of nanoparticles into a flow through substrate. Analytes containing a plurality of targets flow through the flow-through substrate. Electromagnetic radiation is applied to the flow-through plasmonic substrate, such as a plurality of nanoparticles, to cause the plasmonic substrate to support a plasmon, or singular or plurality of nanoparticles to support a localized Surface Plasmon Resonance (LSPR). A change is measured in the refractive index of the analytes flowing through the substrate due to the binding of a plurality of targets to the plamonic substrate, which preferably is a singular or plurality of nanoparticles supporting LSPR, and the applying the radiation.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention will be readily understood from the following detailed description of preferred embodiments taken in conjunction with the accompanying drawings in which:

FIG. 1 is a block diagram view of a transducer system in accordance with the present invention;

FIG. 2 depicts micro channel flow across a substrate and flow through a second substrate;

FIG. 3 depicts a scanning electron microscope image of gold colloids inside a substrate;

FIG. 4 depicts an extinction spectrum of gold colloids embedded in a substrate using layer-by-layer assembly;

FIG. 5 depicts refractive index sensitivity of gold colloids in solution;

FIG. 6 depicts a scanning electron microscope image of gold nanorods resonate at 808 nm inside 200 nm pore and anodized aluminum oxide substrate;

FIG. 7 depicts a schematic illustrating a colorimetric detection of mass flux;

FIG. 8 depicts fluorescence imaging of biotin surface coverage on an anodized aluminum oxide substrate;

FIG. 9 depicts a perspective exploded view of a flow-through versus flow-over fluid configuration;

FIG. 10 depicts a graph of absorption of ortho-nitrophenol as a function of time and depicting flow through and flow-over plots;

FIG. 11 depicts a graph of absorption change for changes for a control substrate lacking biotin showing flow-through and control plots;

FIG. 12 depicts surface coverage of biotin on nanopore-embedded gold nanorods on various samples;

FIG. 13 is a graph of the sensitivity of porous LSPR substrates made with gold nanorods before and after surface modification collected in water; and

FIG. 14 is a graph of the refractive index sensitivity of bare and modified substrates.

### DETAILED DESCRIPTION

In accordance with the principles of the present invention, transducer systems using plasmonic detection methods (e.g., Localized Plasmon Surface Resonance) are provided.

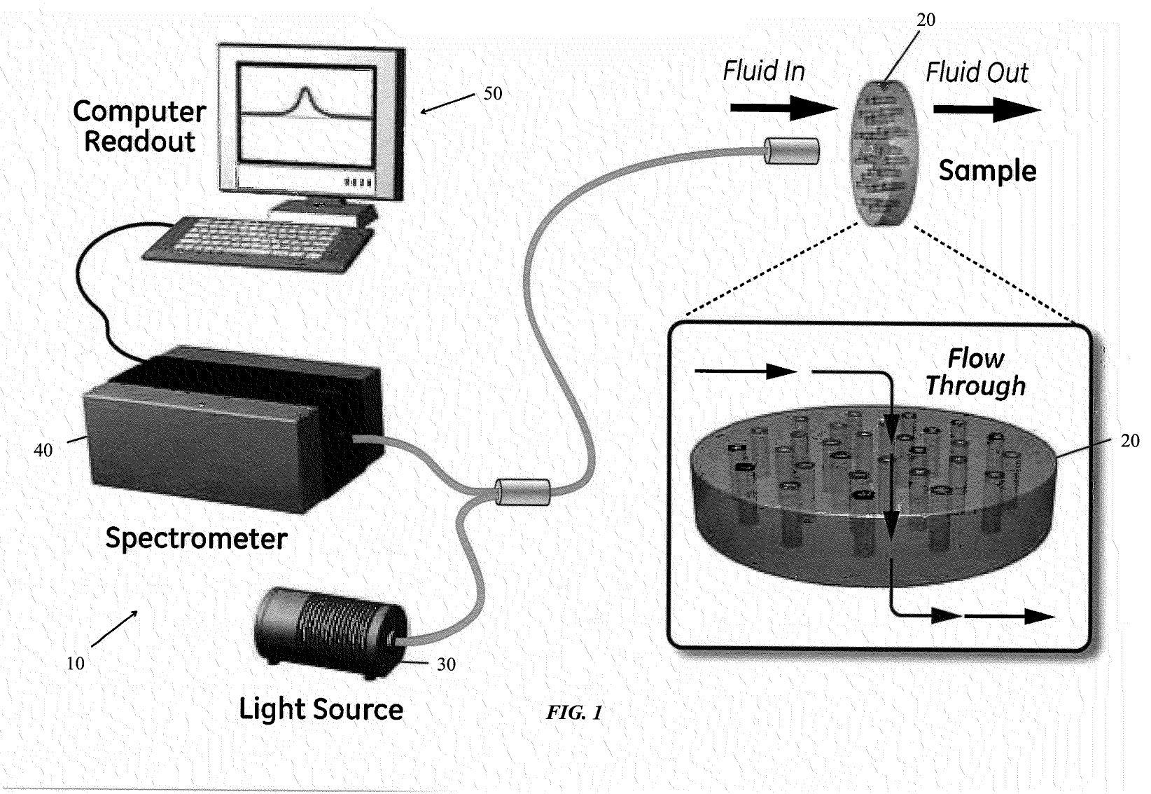

In an exemplary embodiment depicted in FIG. 1, a transducer system 10 includes a flow through substrate 20, a source of electromagnetic radiation (e.g., light) 30 and a receiver 40 (e.g., spectrometer) coupled to a computing unit 50.

Substrate 20 may include internal flow-through pathways, such as nanopores, where the size in a lateral dimension is preferred to be between 1000 μm and 30 nm, or more preferably between 500 nm and 50 nm. The depth, or height or length, of the nanopore is preferred to be between 10000 μm and 500 nm or more preferably between 10 μm and 1000 μm. Substrate 20 may be embedded with, or have disposed thereon, a feature capable of supporting a plasmon (SPR), preferably LSPR, and more preferred a gold nanorod(s) supporting LSPR. Such nanorods may bind to target compounds in an analyte which flows through the nanopores in an interior or surface of substrate 20. The nanorods may be dispersed or substantially nonaggregated to promote such binding and LSPR attributes.

A change in a refractive index of the analyte in the substrate may effect a change in conditions to support plasmon and thus a change in the wavelength of light to excite a plasmon. The change in such refractive index may be detected by receiver 40 (e.g., a spectrometer) which may provide an identification of a target compound binding to the nanorods.

Metallic nanoparticles (e.g., gold nanorods) exhibit a wide array of colors depending on their size, shape, composition, and local dielectric environment. Localized Surface Plasmon Resonance (LSPR) refers to the phenomenon that occurs when light impinges upon a nanoscale metallic object, generating resonant oscillations in the conduction electrons of the metal that give rise to wavelength-selective extinction. The extinction maximum (λₘₐₓ) of the nanoparticle depends upon the refractive index of the local (<30 nm) dielectric environment. Changing the refractive index through changes in the local chemistry (e.g., gas, liquid, solid) or physical (e.g., temp) composition at the nanoparticle surface or other surface that supports a plasmon—for example, through the binding of a biomolecule—causes the λₘₐₓ to shift towards a different wavelength. By taking advantage of surface chemistries available on metallic surfaces, the nanoparticle can be functionalized with bioreceptors that enable selective detection of analytes. In one example, LSPR sensors may be used for the detection of antibody-antigen interactions, DNA hybridization, protein-lectin binding, lipid bilayer formation, and protein conformational changes all of which result in a local change in refractive index upon recognition. SPR sensors, which may include LSPR sensors, may incorporate a range of nanoscale geometries including but not limited to, spheres, rods, shells, disks, rings, crescents, holes, spheroids, pyramids, cubes, and a plurality of other geometric and non-geometric shapes. While these shapes can affect the physical, optical, and electronic characteristics of nanoparticles, the specific shape does not bear on the qualification of a particle as a nanoparticle. Also nano-geometry may equate to nanoparticle.

For convenience, the size of nanoparticles can be described in terms of a “diameter”. In the case of spherically shaped nanoparticle, diameter is used as is commonly understood. For non-spherical nanoparticles, the term diameter, unless otherwise defined, refers to a radius of revolution (e.g., a smallest radius of revolution) in which the entire non-spherical nanoparticle would fit.

Further, the nanoparticles described above as being disposed on, or embedded in, a substrate (e.g., substrate 20) may be formed of a material that can support a photonically excited plasmon as observed as an absorption (or lack of transmission) provided multi-wavelength (or singular wavelength or a value in-between singular and multiple wavelengths)) and have at least one dimension that is below the wavelength of light.

The substrate (e.g., substrate 20) could be any type of material which avoids supporting a plasmon, i.e., it is plasmonically inactive with respect to radiation from a particular source. One example of a material for the substrate (e.g., substrate 20) includes anodized aluminum oxide (AAO) which may be near transparent and wetted. Other examples include glass, quartz, silicon dioxide, gallium nitride, carbon, graphite, porous polymers (such as physical or chemical etched polymers), cellulose, nitrocellulose, PTFE) The substrate may include a plurality of nanochannels or nanopores (e.g., either of organized, independent or tortious path) throughout the substrate to allow a flow of the analytes therethrough. The nanoparticles embedded in the substrate also may be substantially nonaggregated so as to not affect the resonance wavelength of the plasmon supporting substrate (e.g., the resonance wavelength being +/−100 nm of its free solution, non-aggregated, resonance wavelength) in the analytes flowing through the substrate.

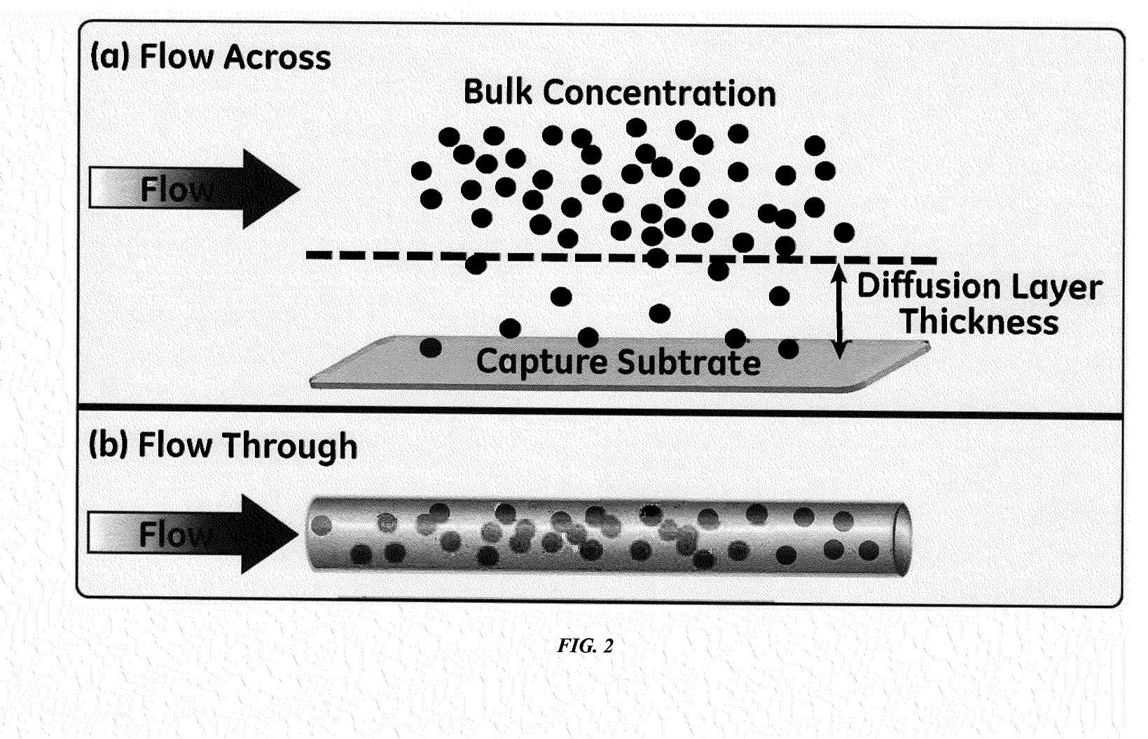

A preferred environment is to couple to LSPR, (e.g., as utilized in system 10) as the signal transduction modality described above due to its superior signal to noise performance and miniaturization potential, as compared to SPR, for example. The transducer or sensor (e.g., system 10) is fabricated by immobilizing gold nanoparticles inside the pores of substrate 20 (e.g., an anodized aluminum oxide (AAO) substrate with 200 nm diameter pores) to allow immobilization of nanoparticles with both positive and negative surface chemistries, theoretically enabling surface modification with any solution-phase nanoparticle geometry. As fabricated, these porous LSPR substrates (e.g., substrate 20) may exhibit refractive index sensitivities of 300-400 nm/RIU, demonstrating minimal sensitivity losses due to substrate effects and good agreement with previously reported values for flat surface LSPR sensors. Such flat surface sensors included those having surface channels (e.g., lateral flow sensors) for analytes instead of flow through channels as in the substrate (e.g., substrate 20) described herein. FIG. 2 depicts such flow across LSPR sensors versus the flow through sensors or transducers of the present invention.

Previous nanohole biosensing has primarily been performed with metallic nanohole films, which support surface propagating plasmons (SPPs) with characteristically large (˜200 nm) sensing volumes above the substrate with 100's of microns in the direction of the substrate plane. These large sensing depths contribute to noise in bioassays by detecting bulk fluctuations from non-homogenous thermal, pressure, and concentration gradients in the environment. In contrast, LSPR sensors as described herein have sensing volumes on the order of 25 nm, closely matching the size scale of biological analytes and thus avoiding signal interference from the bulk environment.

For example, previously, flow through substrates were fabricated by providing nanoholes in plasmonic active thin metal films. This has been shown by Sinton et al. (C. Escobedo, A. G. Brolo, R. Gordon, D. Sinton, Nanofluidics Meets Plasmonics: Flow-Through Surface-Based Sensing, Paper no. FEDSM-ICNMM2010-30176 pp. 599-604, doi:10.1115/FEDSM-ICNMM2010-30176, ASME 2010 8th International Conference on Nanochannels, Microchannels, and Minichannels collocated with 3rd Joint US-European Fluids Engineering Summer Meeting (ICNMM2010), Aug. 1-5, 2010, Montreal, Quebec, Canada; De Leebeeck, A.; Kumar, L. K. S.; de Lange, V.; Sinton, D.; Gordon, R.; Brolo, A. G., Anal. Chem. 2007, 79 (11), 4094-4100.; Eftekhari, F.; Escobedo, C.; Ferreira, J.; Duan, X.; Girotto, E. M.; Brolo, A. G.; Gordon, R.; Sinton, D., Anal. Chem. 2009, 81(11), 4308-4311.; Escobedo, C.; Brolo, A. G.; Gordon, R.; Sinton, D., Anal. Chem. 2010, 82 (24), 10015-10020.) Masson et al., (Live, L. S.; Bolduc, O. R.; Masson, J.-F. o., Anal. Chem. 2010, 82 (9), 3780-3787.) and Altug et al. (Yanik, A. A.; Huang, M.; Artar, A.; Chang, T.-Y.; Altug, H., Appl. Phys. Lett. 2010, 96 (2), 021101.). These nanoholes serve a purpose of channels for fluid flow and a purpose to generate plasmons on the surface. The substrates with perforated plasmonic films have significant contribution from propagating plasmons, reducing the advantages of localized plasmons. In addition, the thin film (about 50 nm thick) and the holes in the thin film provide only corresponding ˜50 nm region for interaction of analyte with plasmonic features. Further, the fabrication and handling of such nanohole arrays proved to be difficult, requiring a significant engineering to control the liquid flow through the nanoholes, because otherwise the nanohole support membrane was easily destroyed by the flow instabilities. However the mass-flux advantage of employing a flow through substrate was established by these works.

In contrast, the methods and systems for the flow-through biological detection disclosed herein operate on individual randomly distributed plasmonic nanoparticles that support localized SPR dispersed throughout a nanochannel. These particles are randomly distributed and provide a larger number of interaction regions per channel (i.e., pore) because the number of particles per pore is more than the thickness of the thin metal film in a nanohole array. The mass-flux disadvantage of nanofeatures as described by Whitman et al. is compensated for by placing the nanoparticles that support localized SPR into the nanochannels which provides for increased mass flux when the sample is flowed through the nanochannels containing the embedded nanoparticles that support localized SPR.

The flow-through format of a substrate (e.g., substrate 20) enables reductions in assay time and sample volumes, enhancing the utility of nanoscale sensors both on the benchtop and in the field. As described below, a simple colorimetric (non-plasmonic) readout scheme shows a flow-through format with AAO nanochannels increases the observed reaction kinetics by 20-fold. A 20-fold gain in mass flux compared to flow-over was also found using the nanoparticle-decorated AAO with the same flow-through assays.

Herein are described two best methods to embed plasmonic articles, (preferably LSPR nanoparticles) into the substrate. The nanoparticles (e.g., gold nanorods) embedded in substrate 20 may be embedded therein using layer-by-layer (LbL) assembly or covalent attachment chemistry, two deposition methods that have been shown to enable controlled, sub-monolayer surface coverage. Such methods minimize the aggregation of nanoparticles which otherwise would have a dramatic effect on both the resonance position and sensitivity of nanoparticles, typically leading to broad extinction peak widths and low sensitivities.

In one example, a modified version of an LbL protocol developed by Bruening (Dotzauer, D. M., Dai, J., Sun, L., & Bruening, M. L., (2006). Catalytic Membranes Prepared Using Layer-by-Layer Adsorption of Polyelectrolyte/Metal Nanoparticle Films in Pourous Supports. Nano Letters, 6 (10), 2268-2272) was used to deposit citrate-capped gold colloids inside the AAO pores to act differently than in this usage, where they used this only as a non-optically active, highly porous catalysis bed where no plamonic spectra was monitored. Spectral data was not provided to show the lack of aggregation, or lack of aggregation effects on the localized plasmon of the embedded nanofeatures in Bruening, et al. LbL has also been used by others (Ko, H.; Chang, S.; Tsukruk, V. V., ACS Nano 2008, 3 (1), 181-188.) to place nanoparticles into nanopores or nanochannels showing aggregation with its corresponding degradation of the non-aggregated plasmonic absorption peak. Ko et al. also includes data indicating that LbL is not a compatible method to place non-aggregated nanoparticles into nanochannels and retain the desired non-aggregated plasmonic features of the nanopraticles.

Regarding employing covalent attachment to embed nanofeatures presenting plasmonic activities (preferably localized surface plasmon resonance) into nanochannels and retain the non-aggregated spectral properties, the prior art (e.g., Sehayek et al. (Sehayek, T.; Lahav, M.; Popovitz-Biro, R.; Vaskevich, A.; Rubinstein, I., Chem. Mater. 2005, 17 (14), 3743-3748.) (as also referenced in Bruening et al.)), shows that attempting to attach nanoparticles within nanopores through covalent attachment leads to significant aggregation of the nanoparticles. Such aggregation leads to degradation of the desired non-aggregated plasmonic features of the embedded nanoparticles.

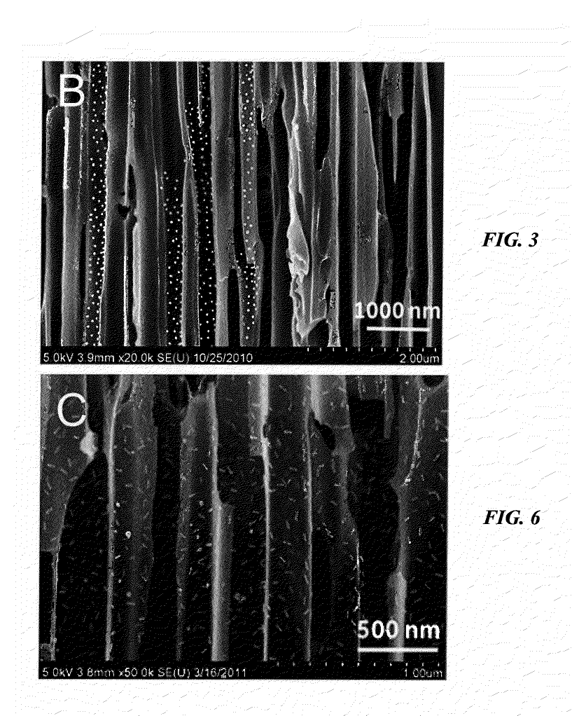

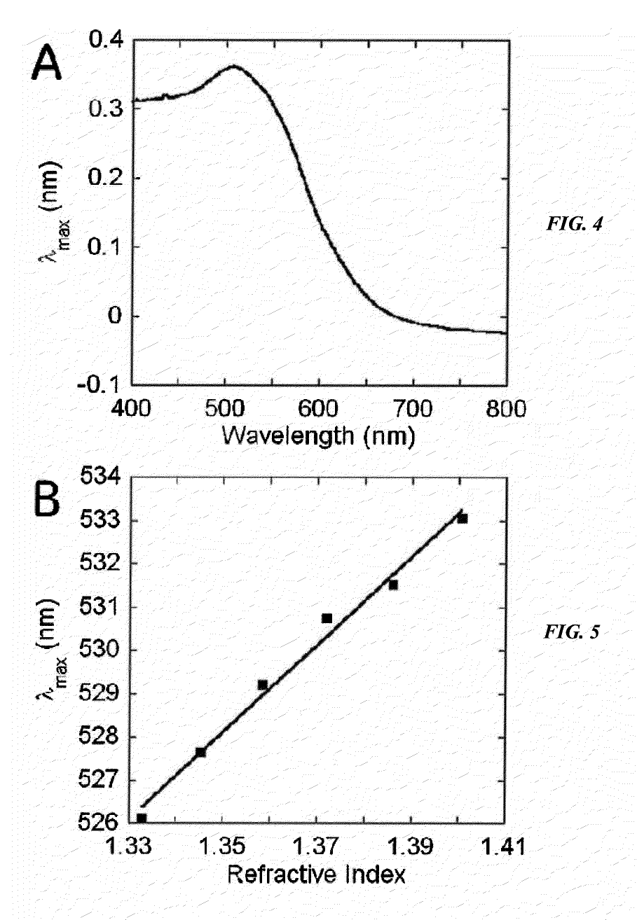

In the here-in described approach, the AAO was first cleaned using an ultraviolet-ozone bake and then mounted in a stainless steel filter holder for subsequent exposure to LbL polyelectrolytes. Flow-through of 20 mM PAA resulted in a surface polyelectrolyte layer presenting positive charges. This was followed by flow-through of 20 mM PAH, a polyelectrolyte presenting negative charges, and another flow-through of 20 mM PAA. The final result was an AAO membrane with three alternating layers of positive and negative charge, with the surface presenting positive charges. In the final step, a ten-fold dilution of 40 nm citrate-capped Au colloids was flowed through the functionalized AAO. Electrostatic and covalent interactions between the negatively charged gold colloids and positively charged amine groups in PAA resulted in uniform and disperse deposition of Au colloids throughout the AAO pores and surface as depicted in FIG. 3 which depicts Scanning Electron Microscope (SEM) image of 40 nm Au colloids inside a 200 nm AAO pore. Spectroscopic characterization of the substrates revealed a single extinction peak with a maximum at 520 nm as depicted in FIG. 4, further confirming the disperse deposition (i.e., non-aggregation) of nanoparticles. The Au colloids exhibited a refractive index sensitivity of 100 nm/RIU (FIG. 5).

In another example, CTAB-capped Au nanorods resonant at 808 nm were embedded in a by modifying the AAO with aminopropyltrimethoxysilane (APTMS) and exposing the functionalized AAO to Au nanorods. This results in uniform and disperse deposition of Au nanorods (FIG. 6), confirming that covalent interactions between amine groups and the Au nanoparticle surface is the primary driving force for deposition of nanorods in AAO.

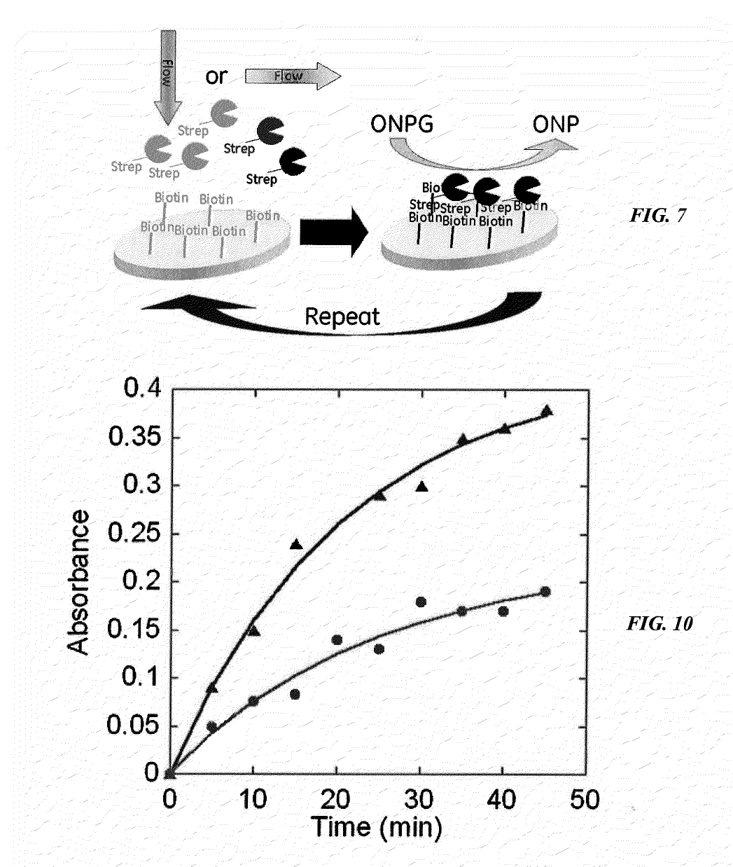

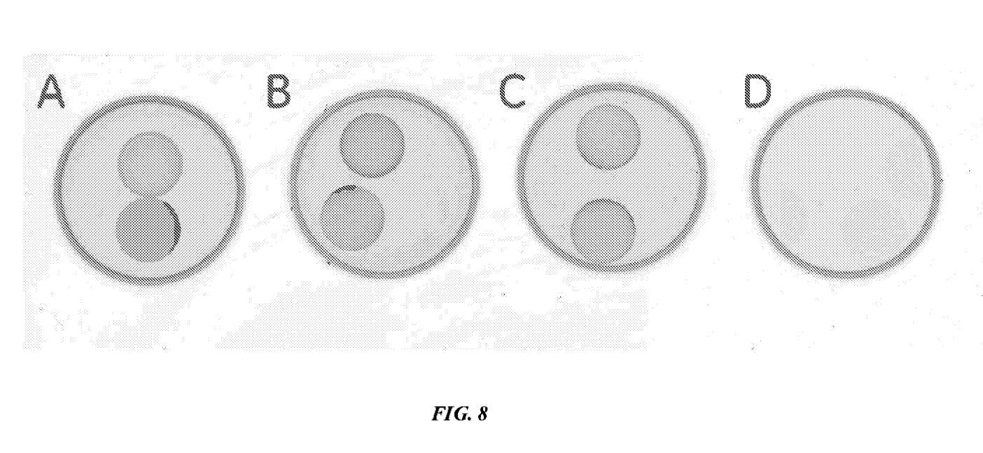

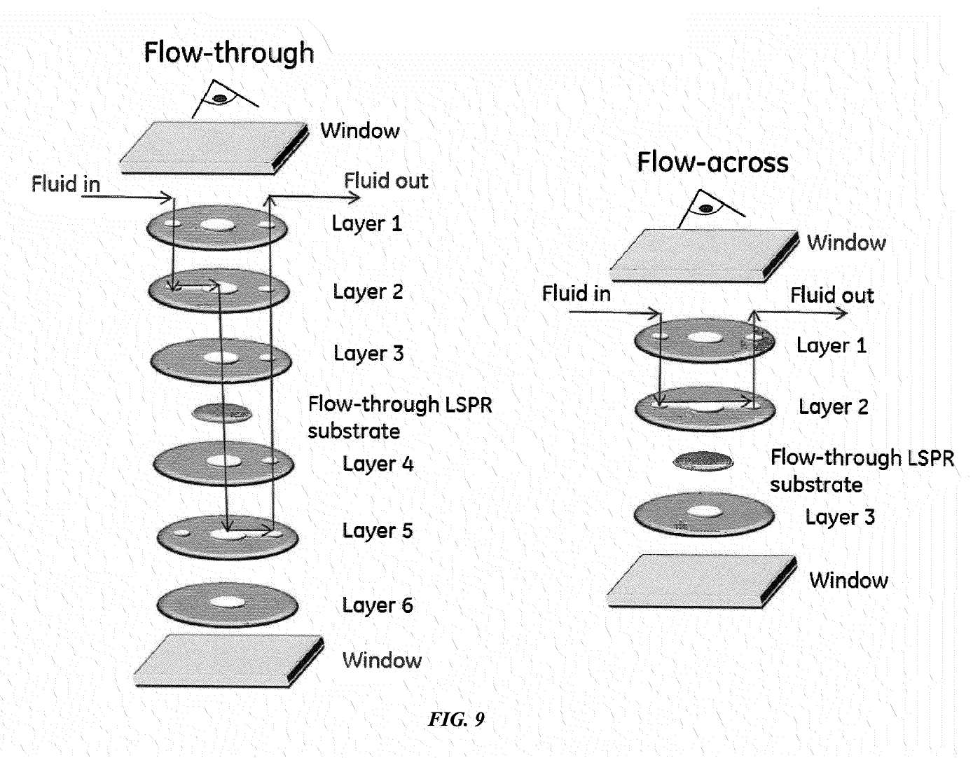

In the non-limiting example, substrate 20 formed of 200 nm pore AAO, as described above, allows flow through (as opposed to surface flow) of analytes of concern. A bioassay with colorimetric readout using an AAO template free of nanoparticles (FIG. 7) was performed to verify mass transport rates independently of LSPR. A template surface was covalently modified throughout with a thiol-terminated silane (mercaptopropyltrimethoxysilane, MPTMS) to allow subsequent modification with maleimide-conjugated biotin. The surface coverage of biotin was confirmed by incubating biotinylated AAO and non-biotinylated controls in fluorescently conjugated streptavidin and imaging for fluorescence intensity as depicted in FIG. 8. To perform the bioassay, biotinylated AAO was mounted in a home-built flow-cell in either a flow-through or flow-over configuration as depicted in FIG. 9 which shows flow-through versus flow-over fluidic configuration in which an analyte solution is directed either through the nanopores of the AAO membrane (flow-through) or over the top of the membrane (flow-over). A transparent window allowed collection of the absorbance inside the flow cell using a reflectance probe. The biotinylated AAO was then exposed to 5 mL of β-galactosidase-streptavidin conjugate with a constant flow rate of 1 mL/min. The streptavidin moiety in the conjugate binds specifically to biotin, immobilizing the β-galactosidase moiety on the AAO surface. In the final step, progress of the reaction between biotin and streptavidin was quantified by flowing 5 mL of orthonitrophenol over the substrate; β-galactosidase converts colorless ONPG to ONP, which has an absorption peak at 420 nm. This cycle of β-galactosidase-streptavidin followed by ONPG was repeated 8-10 times for each assay. A steady-state measurement was taken after each 5 minute cycle to quantify the progress of the reaction. The absorption intensity at each interval was then plotted as a function of time for both the flow-over and flow-through sensor configurations as depicted in FIG. 10. A first order kinetic fit to the data provided a quantitative measure of the reaction rate.

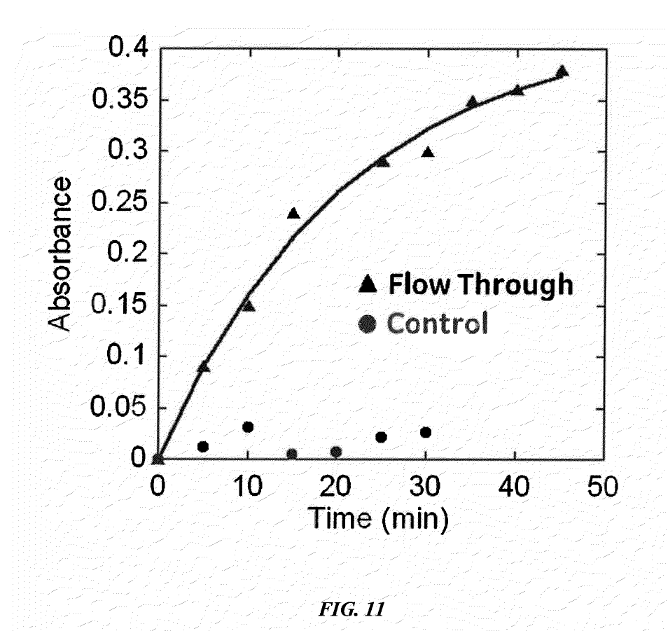

FIG. 10 compares the results for a flow-through assay performed with 0.5 μg/mL β-gal streptavidin to the results for a flow-over assay performed with 5 μg/mL β-gal streptavidin. For the assay time and ONPG concentration used in this example (40 minutes and 5 mg/mL, respectively) the flow-over assay exhibited negligible absorbance at 420 nm at all time points when using 0.5 μg/mL β-gal streptavidin. It was therefore necessary to increase the β-gal streptavidin concentration ten-fold in order to speed the rate of reaction and facilitate comparison to the flow-through assay. The flow-through assay performed with 0.5 μg/mL β-gal streptavidin exhibited an on rate (kₘ) for biotin-streptavidin binding of 21 minutes. In comparison, the flow-over assay performed with 5 μg/mL β-gal streptavidin exhibited an on rate for biotin-streptavidin binding of 25 minutes. Each assay was performed in triplicate, giving average kₒₙ values of 24 minutes for flow-through and 37 minutes for flow-over. It should be noted that the path length for the flow-through absorption measurement was twice the path length for the flow-over measurement, so that the difference in absorption values at saturation observed in FIG. 10 is predicted based on Beer's Law. A control, in which un-biotinylated AAO was exposed to successive cycles of β-gal SA and ONPG, displayed absorption values of less than 0.03 due to the absorption peak at 370 nm of ONPG (FIG. 11). This assay confirmed the mass transport enhancement for flow-through in nanoholes compared to flow-over in microchannels, with flow-over requiring ten times more concentrated analyte to achieve similar binding rates as flow-through. The ten-fold lower concentration used for flow through, coupled with the 1.8× faster binding rate, amounts to an 18× gain in mass transport for the flow-through sensor. Translated differently, the flow-through sensor required 18× less analyte to achieve the same assay time as the flow-over sensor.

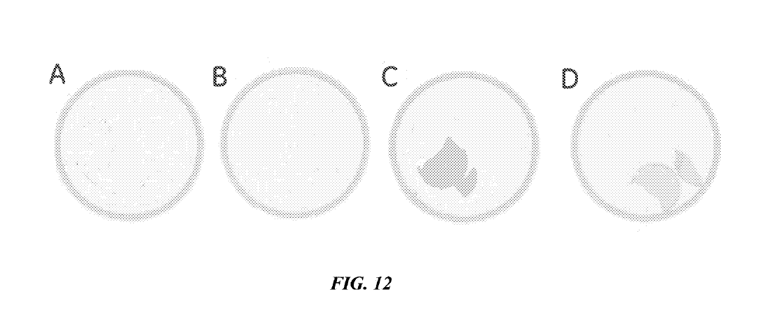

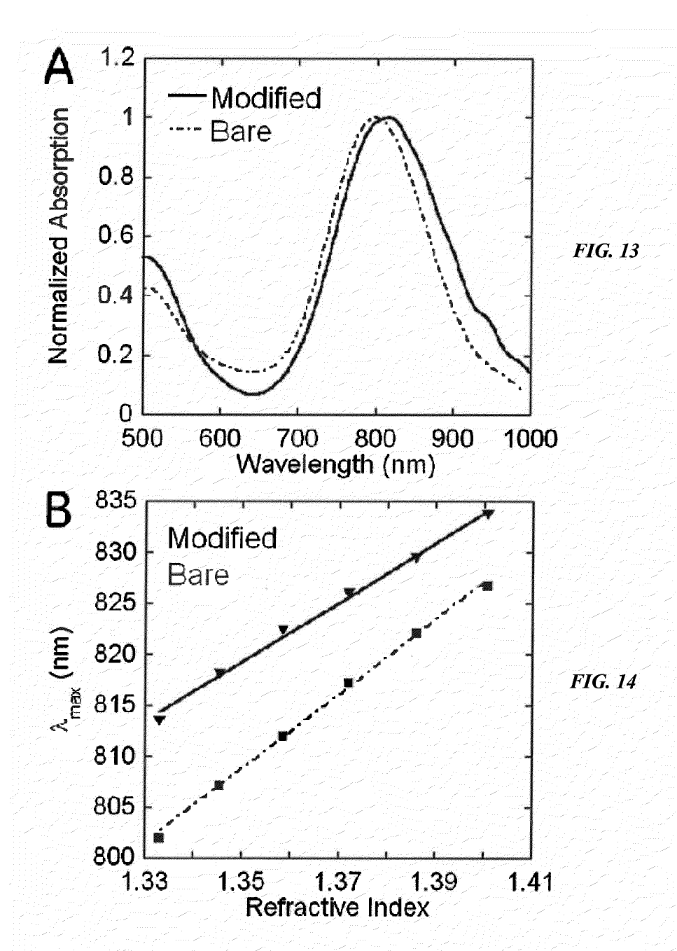

Similar bioassays were performed using the fabricated LSPR nanorod substrates (e.g., substrate 20) described to demonstrate that these mass flux gains can be translated from a simple nanoporous substrate to a plasmonic nanoporous substrate. Prior to performing the bioassay the refractive index sensitivity of the substrates was quantified in order to validate the choice of Au nanorods as the LSPR signal transducer. In addition, the ability to covalently modify the nanorod surfaces with biological receptors was verified using fluorescent endpoint assays (FIG. 12). First, the nanorod-decorated AAO membrane was exposed to aqueous glycerol solutions of varying refractive index (R.I.). At this point the nanorods are unmodified and display the CTAB surfactant used in their synthesis; this is designated herein as the “bare” substrate. The λₘₐₓ of the substrate was measured in each solution and plotted as a function of refractive index, revealing a R.I. sensitivity of 366 nm/RIU. Following this experiment the CTAB surfactant is removed from the surface using a 30 second air plasma treatment, allowing subsequent modification of the Au nanorod surface with a self-assembled monolayer (SAM). A mixed SAM of octanethiol (OT) and 11-mercaptoundecanoic acid (MUA) was allowed to form on the nanorod surface, enabling attachment of an amine-modified biotin via carbodiimide-mediated covalent bond formation with MUA. Following biotin attachment the substrate was incubated in 3% weight/weight bovine serum albumin (BSA) in phosphate buffered saline to block any non-specific adsorption sites. The resulting LSPR substrate that has been cleaned and modified with a SAM, biotin, and BSA is designated the “modified” substrate. The extinction spectra of each of these substrates in milli-Q H₂O are plotted in FIG. 13; the similar peak shape and peak widths of the bare and modified substrate indicate that the modification procedure did not adversely affect the plasmonic properties of the nanorods. The refractive index of the modified substrate was again measured by exposure to aqueous glycerol solutions, and this sensitivity is compared to the sensitivity for the bare substrate in FIG. 14. The presence of adsorbates on the nanorod surface reduced the R.I. sensitivity from 366 nm/RIU to 292 nm/RIU, which is expected based on the exponential decay of the LSPR sensing field moving away from the nanorod surface. However, the R.I. sensitivity of 292 nm/RIU is still higher than numerous geometries used in LSPR sensing, and should therefore provide high sensitivity to biological binding events.

An anti-biotin IgG antibody was used as the analyte to assay mass transport differences for the biotinylated LSPR substrate in the flow-over and flow-through configurations. A 1 mL volume of anti-biotin at a 100 nM concentration was flowed either over or through the plasmonic sensor at a flow rate of 1 mL/min. Following this initial flow, the binding of anti-biotin to the biotinylated sensor surface was allowed to continue under stopped flow until the sensor signal reached saturation. Upon saturation, the sensor was rinsed with 1 mL of PBS at a flow rate of 1 mL/min to allow dissociation of anti-biotin. Dissociation was allowed to continue under stopped flow until the sensor signal equilibrated. Monitoring the change in LSPR λₘₐₓ in real-time as anti-biotin associates or dissociates provides a measure of the surface coverage of the antibody. Fitting these λₘₐₓ changes to a first order exponential therefore enables determination of the association rate (kₐ) and dissociation rate (k_{d}) for the two assays.

The source of electromagnetic radiation (e.g., source of electromagnetic radiation 30) described above could be any means of directing light or other types of electromagnetic radiation toward a substrate (e.g., substrate 20) which may excite the plasmon as described above.

As also described above, receiver 40 may be a spectrometer and further could be any other type of receiver configured to sense a change in a refractive index of an analyte in a substrate by detecting a change in a wavelength of electromagnetic radiation (e.g., light) which is applied to the analyte (e.g., due to the LSPR phenomenon). The receiver thus measures a change in the environment near the plasmonic substrate due to a change in gas, liquid, solid or physical (e.g., temperature) composition. Further, receiver 40 could be a device sensitive to the absorption, or reduced transmission of a specific or multiple wavelengths of light (e.g., filtered photomultiplier tube) to determine the change in absorbance. Such a receiver would be sensitive to the wavelength of light that excites the plasmons which would therefore provide information relative to the changing in a refractive index of an analyte in the substrate.

Further, the receiver (e.g., receiver 40) may be disposed in optical communication with the substrate wherein optical communication is defined as being positioned to measure optical properties of material (e.g., the substrate) on or near the surface of the substrate. The receiver may be coupled via a wired or wireless connection to a computing unit as depicted in FIG. 1 and the receiver may send data to the computing unit for processing (e.g., to sense a change in a refractive index of an analyte in a substrate to allow the identification of a target molecule binding to the nanoparticle) and/or the receiver itself may include an electronic processor which performs such processing.

The use of a flow through substrate with nanopores and embedded nanoparticles coupled with LSPR analysis provides the advantages of minimizing the signal to noise ratio versus other technologies (e.g., SPR) while also maximizing the mass-flux ratio of analytes through the substrate versus surface flow of analytes on the substrate. As described above, in the prior art, such LSPR advantages were at the cost of mass flux. By embedding plasmonic, (e.g., LSPR) substrates into nanopores (e.g., between 1000 mm and 100 nm) the cost of mass flux may be avoided while improving such flux relative to other methods.

Further, sensing by a receiver (e.g., receiver 40) and the identification of a target compound as described above could be negatively affected by noise and other signal degradation. Such noise and degradation may include sensor imperfections, flow-induced sensor-response errors, sensor-to-sensor variability, effects of the sample condition not related to analyte concentration, and variability in the optical readout. Causes for such noise and degradation may include a response of a plasmon resonance structure, flexing or clogging of a flow through structure, imperfections of a sensing structure, difficulties with substrate-two-substrate reproducibility, test sample liquid scatter and absorbance, collimated light variability, spectrometer instability, light source instability, and liquid flow instability.

Further, examples of sensor imperfections include geometrical variability of metallic features, chemical and biological composition of a layer, monolayer, or sub-monolayer, morphology of the metallic features and non-metallic features. Examples of flow-induced sensor-response errors include structure flexing and clogging. Examples of sensor-to-sensor variability include geometrical, morphological, chemical, biological, and physical un-intended differences. Examples of effects of the sample condition not related to analyte concentration include sample color, sample turbidity, temperature, and variation of refractive index due to solvent inhomogeneity. Examples of the variability in the optical readout include instabilities in optical light source, variability of sensor alignment, instabilities in optical wavelength-selection elements, instabilities in optical detector (single-channel or multichannel).

Optical spectra collected from a sensor (e.g., receiver 40) may be analyzed (e.g., by computing unit 50) to correct for the sources of noise and degradation described above. For example, quantitative bioanalytical analysis may be performed (e.g., by computing unit 50) to provide identity information, kinetic information, and concentration information. Tools for providing such information may include: a denoising tool, data acquisition acceleration tool, a fault identification tool, and a tool for multiplexed measurements for high throughout analysis. Nonlimiting examples of denoising tools include smoothing, peak fitting, wavelet analysis. Nonlimiting examples of data acquisition acceleration tool include wavelet analysis and fourier analysis. Nonlimiting examples of fault identification tools are T²- and Q-statistics. Nonlimiting examples of tools for multiplexed measurements for high throughput analysis are microscopic imaging and serial optical scanning. The tools described above may be used by a computer (e.g., computing unit 50) to analyze data collected from a sensor (e.g., receiver 40) as described.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A transducer system comprising:
a source of electromagnetic radiation;
an intrinsically porous dielectric substrate disposed to receive radiation from the source, the substrate comprising a plurality of prefabricated internal through-flow pathways;
a plurality of nanoparticles disposed on the substrate said plurality of nanoparticles comprising a material having a dielectric constant in a range to support a photonically excited Plasmon in response to electromagnetic radiation from the source; and
a receiver for measuring the electromagnetic radiation disposed in optical communication with the substrate.

2. The system of claim 1 wherein said substrate comprises an anodized aluminum oxide (AAO) substrate, said substrate being porous and said pathways comprising pores distributed therethrough.

3. The system of claim 2 wherein said substrate has a thickness to support distribution of at least 5 nanoparticles, and wherein said pores comprise 200 nm pores.

4. The system of claim 1 wherein said substrate comprises at least one of glass, quartz, silicon dioxide, gallium nitride said substrate being porous and said pathways comprising pores distributed therethrough

5. The system of claim 1 wherein said plurality of nanoparticles are shaped as at least one of rods, spheres, shells, disks, rings, crescents, holes, spheroids, pyramids, and cubes.

6. The system of claim 1 wherein said plurality of nanoparticles is substantially non-aggregated.

7. The system of claim 1 wherein said plurality of nanoparticles comprises gold nanorods.

8. The system of claim 1 wherein said substrate comprises plasmonically inactive material with respect to radiation from the source.

9. The system of claim 1 wherein said substrate comprises a plurality of nanopores throughout said substrate to allow a flow of fluid therethrough.

10. The system of claim 1 wherein said receiver comprises a spectrometer coupled to a computing unit, at least one of the spectrometer and computing unit configured to identify the plurality of targets based on a change in a refractive index of an analyte in the pathways.

11. A method comprising:
applying electromagnetic radiation to a substrate having a plurality of internal through-flow pathways;
the substrate having a plurality of nanoparticles disposed thereon, the plurality of nanoparticles comprising a material having a dielectric constant being in a range to support a photonically excited Plasmon in response to the electromagnetic radiation;
a receiver disposed in optical communication with the substrate and measuring the electromagnetic radiation; and
flowing a target through the pathways.

12. The method of claim 11 further comprising flowing an analyte having a target through the flow-through substrate.

13. The method of claim 12 further comprising measuring a change in a refractive index of the analyte flowing through the substrate to obtain a measured change.

14. The method of claim 13 further comprising identifying the plurality of targets based on the measured change.

15. The method of claim 13 wherein the receiver comprises a spectrometer coupled to a computing unit and further comprising identifying a target by at least one of the spectrometer and the computing unit based on the change in the refractive index.

16. The method of claim 11 further comprising embedding the plurality of nanoparticles in the substrate using a layer by layer process.

17. The method of claim 11 further comprising embedding the plurality of nanoparticles in the substrate using a covalent attachment chemistry process.

18. The method of claim 11 wherein the substrate comprises an anodized aluminum oxide (AAO) substrate having 200 nm diameter pores and further comprising flowing the analytes through the pores.

19. The method of claim 11 wherein the substrate comprises at least one of glass, quartz, silicon dioxide, gallium nitride said substrate being porous and said pathways comprising pores distributed therethrough

20. The method of claim 11 wherein the plurality of nanoparticles are shaped as at rods, spheres, shells, disks, rings, crescents, holes, spheroids, pyramids, or cubes.

21. The method of claim 11 wherein the plurality of nanoparticles is substantially non-aggregated.

22. The method of claim 11 wherein the plurality of nanoparticles comprises gold nanorods.

23. The method of claim 11 wherein the substrate is plasmonically inactive relative to the electromagnetic radiation.

24. The method of claim 13 wherein the measuring the change comprises denoising, data acquisition acceleration, and fault identification.

25. The method of claim 24 further comprising providing identity information, kinetic information, and concentration information based on the measuring.

26. The method of claim 24 wherein the measuring provides correction for flow-induced sensor-response errors, sensor-to-sensor variability, effects of the sample condition not related to analyte concentration, and variability in an optical readout.
